(19) United States
(12) Patent Application Publication
(10) Pub. No.: US 2007/0217799 A1
(43) Pub. Date: Sep. 20, 2007

(54) FIXING DEVICE, IMAGE FORMING APPARATUS AND FACSIMILE APPARATUS

(75) Inventor: Kensei Otsubo, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/685,482

(22) Filed: Mar. 13, 2007

(30) Foreign Application Priority Data
Mar. 16, 2006 (JP) 2006-072347

(51) Int. Cl. G03G 15/00; G03G 15/20

(52) U.S. Cl. 399/44; 399/69

(57) ABSTRACT

A fixing device according to this invention includes an environmental temperature sensor 26 for detecting an ambient environmental temperature; a fixing temperature sensor 25 for detecting the surface of a heating roller 20; and a control unit for controlling the heating temperature of the heating roller, and is characterized in that the heating roller 20 is provided with a heater 20a having a luminous-intensity distribution characteristic generating identical heat at both ends and a center in a longitudinal direction; and the control unit determines which level of a plurality of temperatures the environmental temperature belongs to and controls the heating temperature to a prescribed temperature capable of obviating shortage in fixing strength and offset at the determined temperature level.

### BACKGROUND

This invention relates to a fixing device capable of reducing offset generated in a heating roller thereby to form a preferred image regardless of an environmental temperature and preventing sheet feeding failure, and an image forming apparatus and a facsimile apparatus which are provided with the fixing device.

A fixing device for fixing toner on a copying sheet by a pressurizing roller has been generally already known (for example, see: JP-A-4-296787). Now referring to FIGS. 9(a) to 9(c), an explanation will be given of the structure of such a fixing device. FIG. 9(a) is a front view of a conventional fixing device; FIG. 9(b) is a sectional view of FIG. 9(a); and FIG. 9(c) is a structural view of a heater of the fixing device in FIG. 9(a).

As shown in FIGS. 9(a) to 9(c), this fixing device has a hollow heating roller 102 and a pressurizing roller 103 made of rubber which are rotatably pivoted on pivoting plates 101 located upright on both sides. Both rollers are kept in pressure-contact with each other by a pressure-contact means to form a nipping width therebetween. The heating roller 102 and pressurizing roller 103 are rotated synchronously. The copying sheet with toner electrodeposited thereon is pressurized and carried. Thus, the toner is heated and fixed on the copying sheet.

In the hollow portion of the heating roller 102, a coil-shaped heater 105 for heating the heating roller 102 is arranged to pass through it. Considering the fact that the temperature is generally low at both ends of the heating roller 102, the heater 105 is formed with the interval of coils 106 at both ends being close and the interval of coils 107 at a center being loose so that the surface temperature of the heating roller 102 is uniform at the center and both ends. Further, in the fixing device disclosed in Patent Reference 1, the surface temperature of the heating roller 102 is gradually lowered from the center to both ends.

In the fixing device disclosed in JP-A-4-296787, the surface temperature at the center of the heating roller is made higher than that at both ends so that lag in the heat conduction at the center can be compensated for even when the pressure-contact force of the pressurizing roller for the heating roller is weaker at the center than at both ends. Therefore, this fixing device was a very useful device capable of eliminating fixing irregularity in the longitudinal direction and making the fixing strength (fixing rate) uniform.

However, in the fixing device disclosed in JP-A-4-296787, the fixing strength at the center is primarily taken in consideration so that the viewpoint for the fixing characteristic at both ends and the characteristic of offset and others are secondary. Namely, this fixing device could not give an optimum fixing characteristic considering all the viewpoints at both ends and center. Incidentally, the “offset” refers to the fact that the residual toner left on the surface of the heating roller is fixed onto a copy sheet by the subsequent rotation.

The fixing characteristic and the characteristic of the offset and others are in a contradictive relationship. For example, if the surface temperature at both ends rises, the offset occurs at both ends to make the copy sheet dirty. Inversely, suppressing the offset gives rise to shortage in the fixing strength at both ends and center. Likewise, if the surface temperature at both ends rises, sheet feeding failure such as “ear bending” (deformation in both fed and entered ends of a sheet), curl or wrinkles and paper jam will occur.

The temperature of the environment in which the fixing device is placed also influences its characteristics. When the open air (atmosphere within the fixing device) is at a high temperature, if the same fixing is carried out as that at a low temperature, the offset is likely to occur and also generates sheet feeding failure. On the other hand, when the open air is at the high temperature, if the same fixing is carried out as that at the low temperature, the offset is unlikely to occur but shortage in the fixing strength occurs.

### SUMMARY

In view of the above circumstances, an object of this invention is to provide a fixing device that can reduce offsets forms a preferred image regardless of an open air environmental temperature or prevents sheet feeding failure. Another object of this invention is to provide an image forming apparatus and a facsimile apparatus which includes the fixing device.

The fixing device according to this invention comprises: a heating roller for heating a toner on a recording medium; a pressurizing roller for being located oppositely to said heating roller and bringing said recording medium into pressure-contact with said heating roller; an environmental temperature sensor for detecting an environmental temperature around a predetermined device, the fixing device being provided within the predetermined device; a fixing temperature sensor for detecting the surface temperature of said heating roller; and a control unit for controlling the heating temperature of said heating roller, wherein said heating roller has a heater, the heater having a luminous-intensity distribution characteristic generating identical heat at both ends and a center in a longitudinal direction of said heating roller.

An image forming apparatus according to this invention is characterized by comprising a photosensitive body for forming an electrostatic latent image, a developer for developing the electrostatic latent image, a transfer roller for transferring the developed visible image on a carried recording medium, and the above fixing device.

### BRIEF DESCRIPTION OF THE DRAWINGS

FIG. 1 is a sectional structural view of an image forming apparatus according to the first embodiment of this invention.

FIG. 2 is an appearance view of the image forming apparatus according to the first embodiment of this invention.

FIG. 3 is a schematic cross-sectional view of the fixing device of the image forming apparatus according to the first embodiment of this invention.

FIG. 4(a) is a conventional luminous-intensity distribution characteristic view in the fixing device for comparison of the luminous-intensity distribution characteristic; and FIG. 4(b) is a luminous-intensity distribution characteristic view of the fixing device in the image forming apparatus according to the first embodiment of this invention.

FIG. 5 is a partial exploded perspective view of the ejecting side of the fixing device in the image forming apparatus according to the first embodiment of this invention.

FIG. 6 is a partial sectional view the ejecting side of the fixing device in the image forming apparatus according to the first embodiment of this invention.

FIG. 7 is a block diagram of the control section of the image forming apparatus according to the first embodiment of this invention.

FIG. 8 is a flowchart of fixing temperature control in the first embodiment of this invention.

FIG. 9(a) is a front view of a conventional fixing device; FIG. 9(b) is a sectional view FIG. 9(a); and FIG. 9(c) is a structural view of a heater of the fixing device in FIG. 9(a).

### DETAILED DESCRIPTION

Now referring to the drawings, a detailed explanation will be given of the a fixing device employed in the image forming apparatus according to the first embodiment of this invention, particularly the fixing device employed in the facsimile apparatus. It should be noted that the image forming apparatus according to this invention may be any apparatus capable of forming an image through an electrophotography process, and should not be limited to the facsimile. Any apparatus can be adopted which forms an image using toner and fixing the image, like a printer, a composite machine, etc.

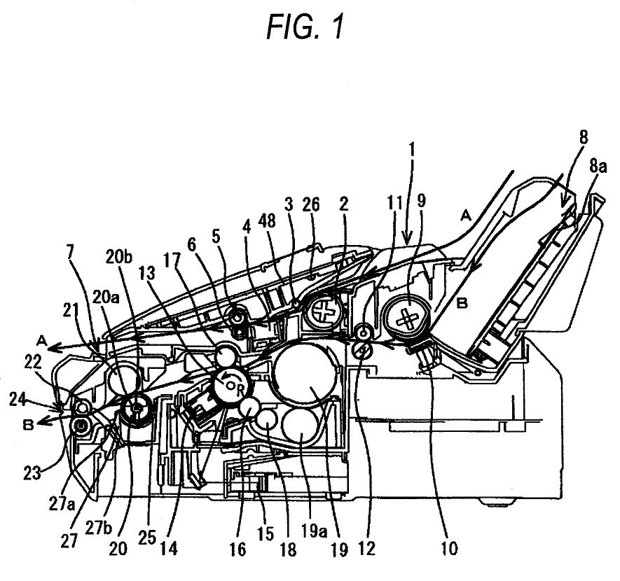

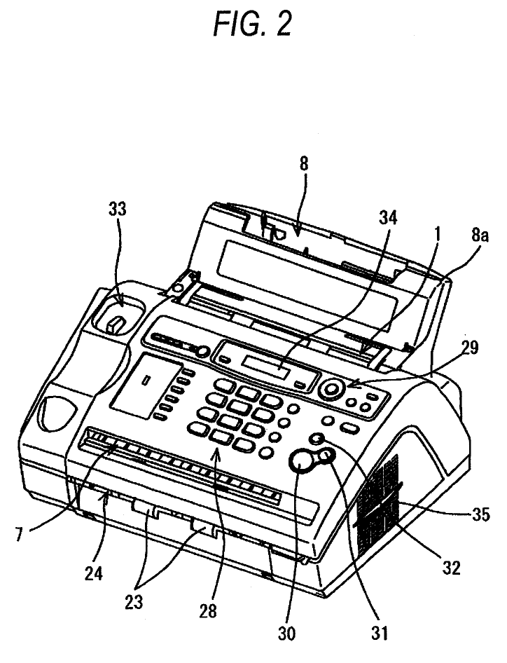

FIG. 1 is a sectional structural view of an image forming apparatus according to the first embodiment of this invention. FIG. 2 is an appearance view of the image forming apparatus according to the first embodiment of this invention. In the facsimile apparatus according to the first embodiment, during facsimile transmission or image reading in a copying mode, a document is carried on a carrying path A so that the document is read, whereas during facsimile reception or image printing in the copying mode, a copying sheet (recording medium in this invention) is carried on a carrying path B so that the image is formed on this copying sheet.

First, the operation of reading the document will be explained. The carrying path A shown in FIG. 1 is employed to read the image. Along the carrying path A, reference numeral 1 denotes a document stack on which a document(s) is placed; 2 denotes a document pickup roller for taking the document from the document stack 1 in the carrying path A; and 3 denotes a document carrying roller for bringing the document carried along the carrying path A into intimate contact with an image sensor unit 4. The image sensor unit 4 incorporates a light source and an image sensor. The document is read by this image sensor unit 4. Reference numeral 5 denotes a document carrying roller for carrying the document supplied from the image sensor 4. Reference numeral 6 denotes a document carrying guide roller making a pair with the document carrying roller 5 and carries the document on the carrying path Awhile sandwiching it. Reference numeral 7 denotes a document ejecting mouth (outlet) for ejecting the document from a facsimile apparatus body (see FIG. 2).

Next, an explanation will be given of the operation of forming the image on the copying sheet during facsimile reception or image printing in the copying mode. As seen from FIG. 1, the copying sheet is carried along the carrying path B so that the copying sheet image-printed on the way is ejected. Along the carrying path B of FIG. 1, reference numeral 8 denotes a feeding stack on which a copying sheet(s) is placed; 8a denotes a feeding tray attached to the feeding stack 8; 9 denotes a document pickup roller for carrying the copying sheets one by one from the feeding stack 8; and 10 denotes a partitioning plate for sending out the copying sheets accommodated in the feeding stack 8 in a manner sandwiched one by one by the document pickup roller 9; 11 denotes a feeding/carrying roller for carrying; and 12 denotes a feeding guide roller.

In FIG. 1, reference numeral 13 denotes a photosensitive drum (photosensitive element in this invention) which rotates in a direction of arrow R; 14 denotes a charger for uniformly charging electric charges on the surface of the photosensitive drum 13; 15 denotes an electrostatic latent image forming unit for emitting laser light or the like which serves to expose the photorsenor drum 13 on the basis of an image signal acquired by the image sensor unit 4 or the image signal received during facsimile reception so that the electrostatic latent image is formed on the surface of the photosensitive drum 13; 16 denotes a developing roller (developer in claim 9 of this invention) for forming a visible image from the electrostatic latent image on the photosensitive drum 13 using toner; 17 denotes a copying roller for copying the visible image of toner on the photosensitive drum 13 on the copying sheet carried along the carrying path B by the feeding/carrying roller 11; 18 denotes a toner supplying roller; 19 denotes a toner accumulating unit (toner bottle); and 19a denotes a paddle roller.

Further, reference numeral 20 denotes a heating roller with surface coarseness of about 0.6 Ra for heating/fixing the visible image on the copying sheet while the copying sheet with the visible image of toner copied thereon is carried along the carrying path B; 20a denotes a heater such as halogen lamp provided within the hollow heating roller 20; and 20b denotes a filament for current-carrying provided within the heater 20a. Further, reference numeral 21 denotes a pressurizing roller being in pressure-contact with the heating roller 20 and having a rubber layer or sponge layer formed on the surface thereof; The heating roller 20 and the pressurizing roller 21 are pressure-contact with each other by a pressure-contact means (not shown) to form a nipping width therebetween. The heating roller 20, pressurizing roller 21 and others constitute the fixing device according to the first embodiment of this invention. Reference numeral 22 denotes an ejecting roller for ejecting the copying sheet with the image recorded thereon; 23 denotes a guide roller (see FIG. 2) for ejecting the copying sheet by its pair with the ejecting roller 22; and 24 denotes an ejecting mouth (see FIG. 2) for ejecting the copying sheet after recording.

Further, in FIG. 1, reference numeral 25 denotes a fixing temperature sensor, such as a thermometer, which is arranged in the vicinity of the heating roller 20 to detect the heating temperature of the heater 20a or the surface temperature of the heating roller 20. Reference numeral 26 denotes an environmental temperature sensor 26 (see FIG. 1) which is arranged within the facsimile apparatus to detect the temperature of the inside air, i.e. the environmental temperature. The fixing device according to the first embodiment controls the heating temperature of the heating roller 20 considering the ambient environmental temperature of the heating roller 20 in order to reduce the offset generated on both sides of the heating roller 20 to form a preferred image regardless of the environmental temperature. The detail of this operation will be explained later.

Further, reference numeral 27 denotes an ejected-sheet guide (fixed recording medium guide in this invention) which is arranged between the heating roller 20, pressurizing roller 21 and the ejecting mouth 24; and 27a denotes notches formed on both sides in the width direction of the copying sheet of the ejected-sheet guide 27. The details thereof will be also explained later. Incidentally, reference numeral 27b denotes an ejection sensor for detecting the copying sheet to be ejected.

Next, referring to FIG. 2, an explanation will be given of the appearance of the facsimile apparatus according to the first embodiment. In FIG. 2, reference numeral 28 denotes 12 keys including ten numerical keys employed input a dial number of a transmission destination and “*” and “#”. Reference numeral 29 denotes a function member composed of keys and dials employed to operate various functions such as speed dialing registering and re-dialing; 30 denotes facsimile transmission start key; 31 denotes a copy key for designating a copy mode; and 32 denotes a stop key for designating stop of processing. Further, reference numeral 33 denotes a handset stand on which a handset is placed; 34 denotes a liquid crystal display (hereinafter referred to as LCD) for displaying a date, a telephone number and characters such as a guidance; and 35 denotes fan air bents for a cooling fan for dissipating inside heat.

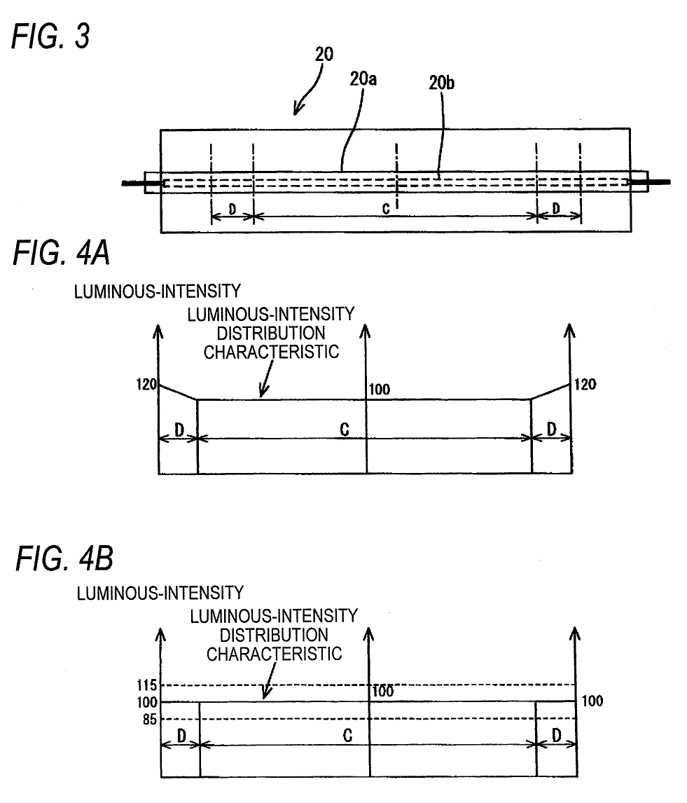

Now, an explanation will be given of the fixing device of a facsimile apparatus according to the first embodiment. FIG. 3 is a schematic cross-sectional view of the fixing device of the image forming apparatus according to the first embodiment of this invention. FIG. 4(a) is a conventional luminous-intensity distribution characteristic view in the fixing device for comparison of the luminous-intensity distribution characteristic. FIG. 4(b) is a luminous-intensity distribution characteristic view of the fixing device in the image forming apparatus according to the first embodiment of this invention. In FIG. 3, reference numeral 20a denotes a heater such as a halogen heater. The heater 20a is provided so that a filament 20b penetrates the heating roller 20. As understood from the luminous-intensity distribution characteristic shown in FIG. 4(b), the heater 20a according to the first embodiment has identical characteristics in a central area C and areas of both ends D. So, with no difference between both characteristics, the distribution of the heating value is constant. As long as the heating value is made constant, the filament 20b may be wound in any manner. Now, the luminous intensity of the luminous-intensity distribution characteristic is defined as T/T₀ (%) (T represents a heating temperature at each of positions of the heater; and T₀ represents the heating temperature at the central area of the heater which is a standard).

On the other hand, in a conventional heater, as seen from FIG. 4(a), the luminous intensity of the areas of both ends D is higher than that of the central area C. Specifically, with the winding interval of the filament 20b being close in the areas of both ends D, the heating value in these areas is made higher at a position nearer to both ends in the longitudinal direction; and with the winding interval of the filament 20b in the central area C being close, the heating value in the central area C is made basically constant. The reason thereof is as follows. In the conventional heater, when heat is removed, the surface temperature in the areas of both ends D becomes lower than that in the central area C so that avoiding shortage in the fixing strength is primarily taken into consideration.

Incidentally, in the conventional heater also, if only the central area C is taken out, the distribution of the heating value is constant. So, as the case may be, the image quality can be made preferable. However, in this case, the heating distribution is made constant in only the central area C. Unlike the first embodiment, the surface temperature of the areas of both ends D is not made identical to the luminous-intensity distribution characteristic of the central area C.

Meanwhile, as in the conventional heater, if the surface temperature in the areas of both ends D is raised, the offset occurs at both ends of the heating roller to smear the copying sheet. Simultaneously, sheet feeding failure such as “ear bending”, curl or wrinkles and jam (paper jam) will occur. In order to avoid such inconvenience, if suppression of the offset is attempted, this results in shortage in the fixing strength in both of both ends D and central area C. Namely, the fixing capability of toner is good at a high temperature, but exfoliation is apt to occur at a low temperature. Further, owing to this property of toner, the offset is apt to occur at a high temperature and is unlikely to occur at a low temperature. Therefore, improvement of the fixing capability and avoidance of the offset and others are in a contradictive relationship.

So, in order to overcome this contradictive relationship, the inventors of this invention repeated experiments to eagerly investigate the optimum condition which can, with no contradiction, satisfy the relationship among shortage in the image strength, sheet feeding failure and jam. As a result, they found that if a specific luminous-intensity distribution characteristic is given to the central area C and the areas of both ends D regardless of the looseness/closeness of the winding interval of the filament 20b, i.e. the luminous-intensity distribution characteristic is constant or the distribution of the heating value is constant, all the shortage in the image strength, sheet feeing failure and jam can be cancelled.

TABLE 1

| | Fixing Characteristic | | | | | |
|---|---|---|---|---|---|---|
| Luminous- | | | | | | Fixing |
| intensity (%) | Offset | JAM | Ear-bending | Curl | Wrinkles | Strength |
| 120 | X | X | X | X | X | ⊚ |
| 110 | Δ | Δ | Δ | Δ | Δ | ◯ |
| 100 | ⊚ | ◯ | ◯ | ◯ | ◯ | ◯ |
| 90 | ◯ | ◯ | ◯ | ◯ | ◯ | Δ |
| 80 | ◯ | ◯ | ◯ | ◯ | ◯ | X |

Table 1 indicates that if the luminous-intensity T/T₀ at both ends is 110 (%) and 120 (%) like the conventional luminous-intensity distribution characteristic, the fixing strength is very favorable but there is high possibility of occurrence of the offset, sheet feeding failure and jam; and if the luminous-intensity T/T₀ is 90 (%) and 80 (%), the fixing strength at both ends is inferior but there is low possibility of occurrence of the offset, sheet feeding failure and jam.

However, according to the combination of the property of toner (composition, and plus or minus of the polarity), property of the conductivity or non-conductivity of the heating roller 20 and property of the conductivity or non-conductivity of the pressurizing roller 21, the concrete numerical value of the heating temperature varies. For example, as regards the first combination of the plus toner, conductive heating roller 20 and non-conductive pressurizing roller 21 and the second combination of the minus toner, non-conductive heating roller 20 and conductive pressurizing roller 21, the first combination requires a higher fixing control temperature by several ° C. than the second combination. However, if both cases are represented in terms of the luminous-intensity, they exhibit the common luminous-intensity distribution characteristic which gives an optimum heating temperature distribution.

In this way, in the fixing device in the facsimile apparatus according to the first embodiment, paying attention to the fact that there are, in pinpoints, luminous-intensity distribution characteristics capable of satisfying all the points of the fixing strength, offset, sheet feeding failure and jam, the luminous-intensity distribution characteristic of the luminous-intensity of 100 (%) is adopted in which the luminous-intensity is constant between the central area C and the areas of both ends D so that the heating distribution of the heating value is constant along the longitudinal direction of the heater. If compatibility at least between the satisfaction of the fixing strength and the avoidance of the offset can be realized, all the fixing strength, offset, sheet feeding failure and jam can be controlled optimally. Thus, the production cost of the heating roller can be also reduced.

Further, the inventors of this invention has gained the knowledge that in order to realize a practical fixing device with the luminous-intensity distribution characteristic of the luminous-intensity of 100 (%), unless fine control is done considering the open air environmental temperature, the optimum state cannot be maintained. In regard to this, the reason why the desired luminous-intensity distribution characteristics existing in pinpoints were overlooked is that the satisfaction of the fixing capability is mainly indented, but also that such characteristics could not be found because they were embedded in the environmental temperature with relatively large variations.

Incidentally, the above heating temperature T₀ is 170° C. in the case where the printing is carried out at the printing speed of 10 ppm with light emission by a halogen lamp at 230 V using the plus toner, conductive heating roller (surface coarseness of 0.6 Ra) and non-conductive pressurizing roller (rubber hardness of JIS 50 degree) under the environmental temperature of 26° C. and environmental humidity of 50%. However, this heating temperature of 170° C. is preferable in only the level of normal temperature range of the environmental temperature of 25 to 30° C. (inclusive). In the low temperature range of 15° C. or lower, range of 15° C. to 25° C. (inclusive), and the high temperature range higher than 30° C., other heating temperatures T₀ are preferable, respectively. It should be noted that the heating temperature T₀ is not varied so greatly by other causes than the environmental temperature θ. These respective temperature ranges refer to a plurality of temperature levels in this invention.

At present, there are many image forming apparatuses. However, without exception, they are proposed under the specification for use at normal temperature. Optimizing only the fixing strength like before has only to consider adaptation to the use at normal temperature. However, as in this invention, in order to carry out the fine control for optimizing all the conditions of the fixing capability, offset avoidance, sheet feeding failure, jam, etc. the temperature control considering the environmental temperature is not indispensable.

Accordingly, the fixing device of the facsimile apparatus according to the first embodiment realizes the control of optimizing all the temperatures the conditions of the fixing strength, offset, sheet feeding failure, jam, etc. in view of the relationship among the open air environmental temperature θ1 measured by the environmental temperature sensor 26, temperature θ2 detected by the fixing temperature sensor 25 (heating temperature of the heater 20a or surface temperature of the heating roller 20) and the heating temperature T₀. In short, if the environmental temperature θ1 and the temperature θ2 satisfies the relationship indicated in Table 2, the optimum control can be realized.

| Environmental | Fixing | Accumulated | | |
|---|---|---|---|---|
| Temperature Sensor | Temperature | Heat Total | Fixing Stabilizing | Fixing Control |
| θ1 | Sensor θ2 | Value | Time | Temperature |
| 0° C. or lower | lower than 130° C. | less than 5500 | 20 s | |
| | | 5500 or more | 20 s | |
| | 130° C. or higher | less than 5500 | 20 s | |
| | | 5500 or more | 20 s | |
| 0° C. to 5° C. | lower than 130° C. | less than 5500 | 20 s | 185° C. |
| (inclusive) | | 5500 or more | 20 s | |
| | 130° C. or higher | less than 5500 | 20 s | |
| | | 5500 or more | 0 s | |
| 5° C. to 10° C. | lower than 130° C. | less than 5500 | 20 s | |
| (inclusive) | | 5500 or more | 20 s | |
| | 130° C. or higher | less than 5500 | 20 s | |
| | | 5500 or more | 0 s | |
| 10° C. to 15° C. | lower than 130° C. | less than 5500 | 20 s | |
| (inclusive) | | 5500 or more | 20 s | |
| | 130° C. or higher | less than 5500 | 20 s | |
| | | 5500 or more | 0 s | |
| 15° C. to 20° C. (incl) | — | — | 0 s | 180° C. |
| 20° C. to 25° C. (incl) | — | — | | |
| 25° C. to 30° C. (incl) | — | — | 0 s | 170° C. |
| higher than 30° C. | — | — | 0 s | 165° C. |

On the basis of this table 2, in the fixing device according to the first embodiment of this invention, in the range where the open air environmental temperature is in the lower temperature range of 0° C. or lower and in the range of 15° C. or lower, control is made at the fixing control temperature=185° C. Further, in the slight low temperature range higher than 15° C. but 25° C. or lower, the control is made at the fixing control temperature=180° C. In the normal temperature range higher than 25° C. but 30° C. or lower, the control is made at the fixing control temperature=170° C. In the high temperature range higher than 30° C., the control is made at the fixing control temperature=165° C.

However, in this case, the control is made under the determination on whether or not the fixing stabilizing time should be given according to whether the temperature θ2 detected by the fixing temperature sensor 25 is lower than 130° C. or 130° C. or higher and whether or not the accumulated heat total value is not smaller than a predetermined count value. This fixing stabilizing time is given for the purpose of stabilizing the fixing capability and affected by a plurality of causes such as the nipping width, rubber hardness of the pressurizing roller 21, printing speed, heating roller control temperature (pressurizing roller heat accumulating temperature), environmental temperature and humidity, copying sheet, heating roller diameter and ON/OFF timing of the heater. In the first embodiment, in order to determine necessity of the fixing stabilizing time, the state of heat dissipation by the cooling fan is adopted as a parameter.

Thus, in the fixing device according to the first embodiment of this invention, attention is not paid to only the fixing strength but is paid to all of the fixing strength, offset, sheet feeding failure, jam, etc. and contrary to common knowledge for the conventional heater 20a, with the distribution of the heating value being made constant over the central area C and areas of both ends D, the optimum condition is attained in a pinpoint manner. However, of the points to which attention is paid, if the compatibility at least between the satisfaction of the fixing strength and the avoidance of the offset can be realized, all the fixing strength, offset, sheet feeding failure and jam can be controlled optimally. As seen from FIG. 4(b), the luminous-intensity distribution characteristic varies within a range of the lower limit of 85 (%) to the upper limit of 115 (%) around the luminous intensity of 100 (%) according to the environmental temperature θ1.

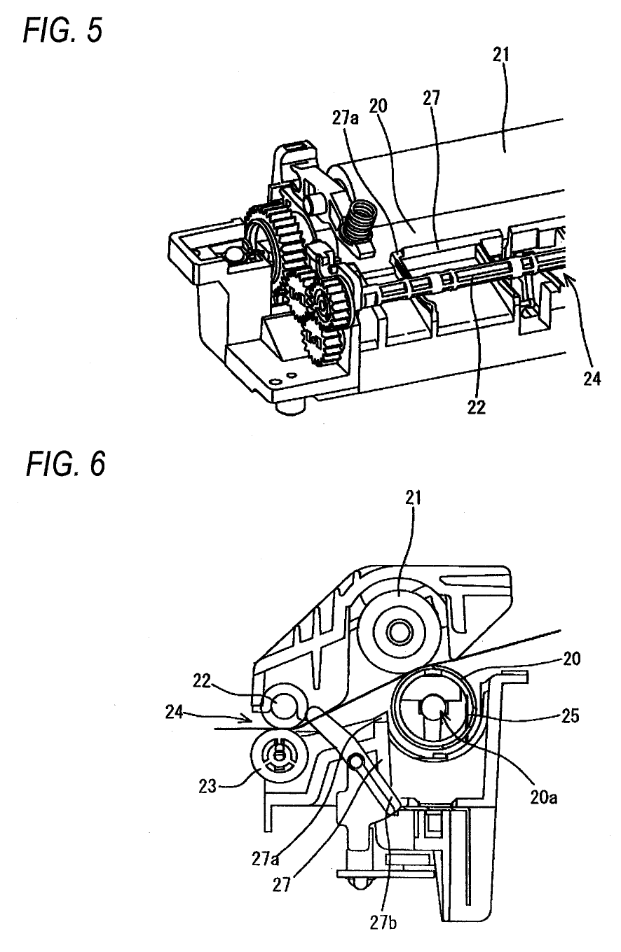

Meanwhile, in the fixing device according to the first embodiment, in order to surely prevent the sheet feeding failure such as “ear bending” (deformation in both fed and entered ends of a sheet), curl or wrinkles and jam from occurring, a countermeasure is taken for the physical structure also. FIG. 5 is a partial exploded perspective view of the ejecting side of the fixing device in the image forming apparatus according to the first embodiment of this invention. FIG. 6 is a partial sectional view of the ejecting side of the fixing device in the image forming apparatus according to the first embodiment of this invention.

The copying sheet after fixing ejected from between the heating roller 20 and pressurizing roller 21 is unlikely to come off owing to the adhesive force of the molten toner so that a difference in the separating force is generated between the areas of both ends D and the central area C. Thus, both fed and entered ends of the copying sheet will be bent. Further, wrinkles may be generated owing to the pressure-contact force between the heating roller 20 and pressurizing roller 21 and temperature distribution in the longitudinal direction. The fixing device according to the first embodiment is finely temperature-controlled so that a large difference in the fixing capability is not generated between the central area C and areas of both ends of the heating roller 20. So, sheet bending of the ejected copying sheet owing to the temperature distribution in the longitudinal direction hardly occur. However, in order to prevent the sheet feeding failure such as “ear bending”, curl or wrinkles and jam from occurring even if both fed and entered ends of the copying sheet are ejected in a slightly bent state, the notches 27a formed at the ejected-sheet guide 27 as shown in FIGS. 5 and 6 serve to avoid the collision of both fed and entered ends of the copying sheet with the ejected-sheet guide 27 so that they are made free. Thus, in the copying sheet ejected from the fixing device of the image forming apparatus according to the first embodiment, the sheet feeding failure and jam will not be generated, thereby greatly improving the printing quality.

In this way, in the fixing device in the image forming apparatus according to the first embodiment, with the temperature distribution in the longitudinal direction being uniform, heating is carried out at the temperature under the optimum condition. For this reason, no wrinkles are generated and the ear-bending, curl, and jam will be generated with very low possibility. In addition, since the ejected-sheet guide 27 is provided with the notches 27a so that the copying sheet after fixing ensures its freedom and both fed and entered ends of the ejected copying sheet are not obstructed by the ejected-sheet guide 27. Thus, the occurrence possibility of the ear bending, curl, and jam can be further lowered.

Although the explanation has been made with reference to an example of the heating temperature T₀, the surface coarseness of the heating roller 20 being about 0.6 Ra (in other words, the value of arithmetic average coarseness is 0.6 μm) contributes to making the jam in the fixing device according to the first embodiment unlikely to occur and lengthen the life of the fixing device. Specifically, by setting the surface coarseness at about 0.6 Ra (0.5 Ra to 0.7 Ra, preferably 0.6 Ra), the surface of the heating roller 20 with the rubber hardness of JIS 50 degree is finished with no grinding. This leads to the structure in which the toner is unlikely to be deposited on the surface layer of the conductive heating roller 20. If the surface layer is fine, toner particles with about 9 μm are apt to be deposited on the surface layer of the heating roller 20. Inversely, if the surface is coarse, the toner particles are unlikely to be deposited.

In the case of the image forming apparatus providing high image quality (1200 dpi or more), in many cases, the surface layer of the heating roller 20 is ground to finish the surface layer into a very fine surface with the surface coarseness of 0.2 Ra or less. However, in the facsimile apparatus such as the first embodiment, all the problems including not only the image quality but also the fixing strength, offset, sheet feeding failure, jam, etc. must be solved simultaneously. Therefore, the surface is not made modestly fine, but inversely finished with no grinding. This makes it possible to prevent the jam, realize the image quality of 6000 dpi and lengthen the life of the fixing device.

Further, an explanation will be given of the respective modes of during the fixing control mode in the facsimile apparatus according to the first embodiment. As seen from FIGS. 1 and 2, with the copying sheets being placed on the document stack 1 of the facsimile apparatus according to the first embodiment, an image signal is received through a telephone line, or the copy key 31 is depressed. Then, the fixing control is started and before a printing signal is supplied from the CPU, the facsimile apparatus enters a stand-by mode of making the image forming apparatus of the facsimile apparatus printable. In this mode, the heating roller 20 is abruptly heated to the fixing control temperature. The fixing control temperature is selected in view of the environmental temperature. After this temperature is reached, when the printing signal is inputted, necessity of the fixing stabilizing time is determined by the above accumulated heat total value. If the fixing stabilizing time is required, the facsimile apparatus enters a fixing stabilizing mode. After stand-by for the fixing stabilizing time, the printing is started. If it is determined that the fixing stabilizing time is not required, the printing is immediately started.

In the printing mode of executing the printing, the surface of the photosensitive drum 13 is scanned with the laser light emitted from the electrostatic latent image forming unit 15 according to the image signal stored in the image memory from the telephone line or the read image signal. Since the photosensitive drum 13 has been charged with the polarity opposite to the toner by the charger 14, by this scanning, the electrostatic latent image is formed on the surface of the photosensitive drum 13. Further, when a developing bias voltage is applied to the developing roller 16, the electrostatic latent image formed on the photosensitive drum 13 is developed with the toner, thereby making the visible image of the toner. This image is transferred to the copying sheet by the copying roller 17 so that the image corresponding to the image signal is printed on the copying sheet to be ejected.

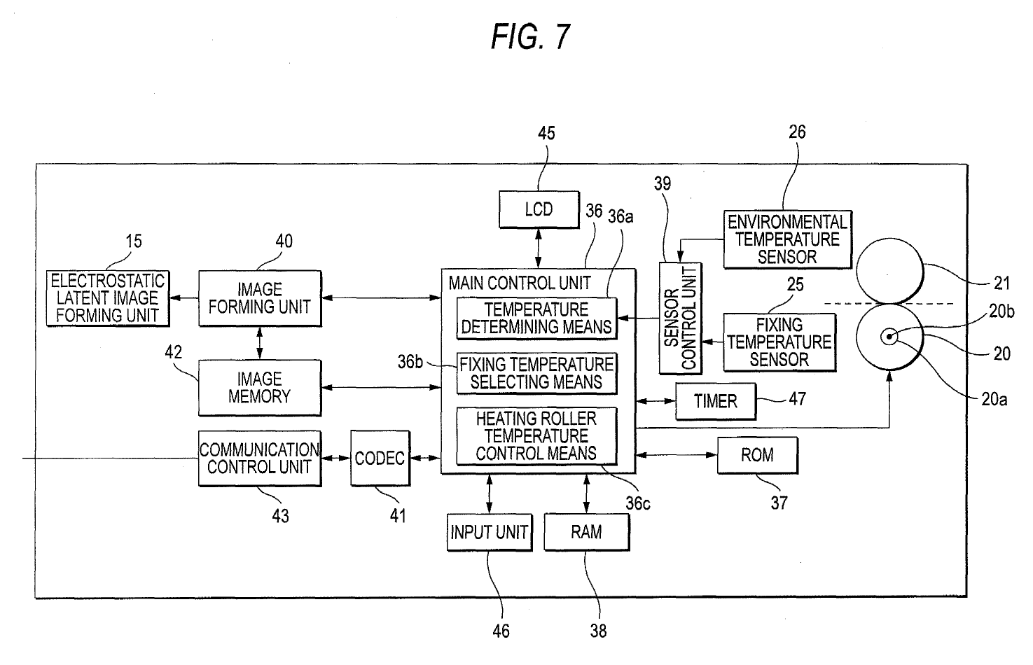

Further, an explanation will be given of the construction of the control section of the facsimile apparatus according to the first embodiment. FIG. 7 is a block diagram of the control section of the image forming apparatus according to the first embodiment of this invention. In FIG. 7, reference numeral 36 denotes a main control unit composed of a CPU (central processing unit) serving as hardware and a read program to control the entire facsimile apparatus. Reference numeral 37 denotes an ROM for storing a program for the main control unit 36; 38 denotes a RAM which is a storage area for work of the main control unit 36; 39 a sensor control unit for making corrections for the detected signals from the fixing temperature sensor 25 and environmental temperature sensor 26; and 40 denotes an image forming unit for supplying the image signal to the electrostatic latent image forming unit 15. Incidentally, the ROM 37 also includes a non-volatile memory such as a flash memory.

Reference numeral 41 denotes a CODEC for encoding/decoding the image signal; 42 denotes an image memory for storing the encoded image signal; 43 denotes a communication control unit for executing communication control through a telephone line; 44 (not shown) denotes the telephone line; 45 denotes a display control unit for controlling the display of an LCD (liquid crystal display) 34 (not shown); 46 denotes an input unit for executing input control for the twelve keys 28 and function member 29; 47 denotes a timer for measuring the fixing stabilizing time; and 48 (not shown) denotes an operating board provided with the input unit 46 and the environmental temperature sensor 26 on the rear side.

Further, in the first embodiment, the main control unit 36 includes the following function realizing means for executing the above fine temperature control. Reference numeral 36a denotes a temperature determining means for determining the respective temperatures on the basis of the detected signals of the fixing temperature sensor 25 and environmental temperature sensor 26, supplied from the sensor control unit 39. Reference numeral 36b denotes a fixing temperature selecting means for selecting the fixing control temperature in four temperature levels according to the table (Table 2) stored in the non-volatile memory on the basis of the temperature determined by the temperature determining means 36a. Reference numeral 36c denotes a heating roller temperature control means for controlling the heating value of the filament 20b in response to the selection result from the fixing temperature selecting means 36b. On the basis of the output from the heating roller temperature control means 36c, the current from an AC power source is controlled by an AC control means (not shown) thereby to control the surface temperature of the heating roller 20.

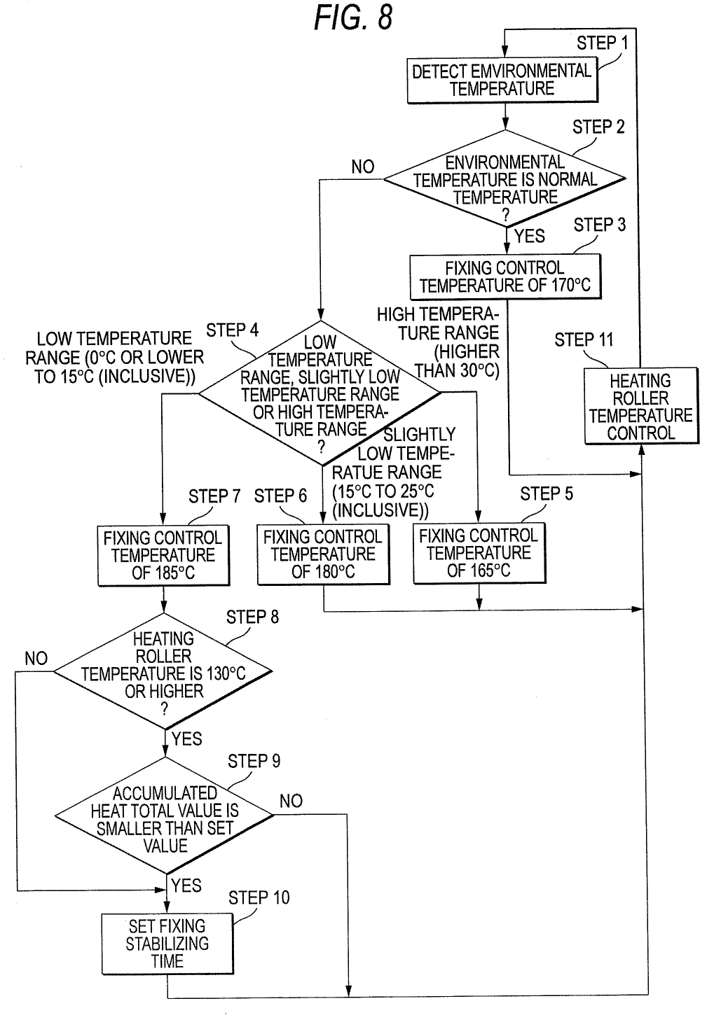

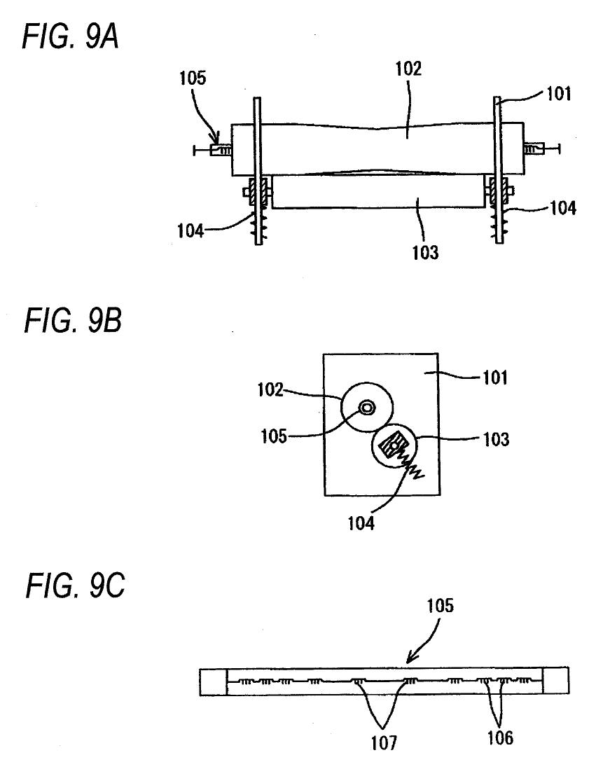

So, an explanation will be given of the control operation for the fixing device of the image forming apparatus according to the first embodiment of this invention. FIG. 8 is a flowchart of fixing temperature control in the first embodiment of this invention. As seen from FIG. 8, the fixing device, when it forms the image, detects the environmental temperature θ1 by the fixing temperature sensor 25 (step 1). Next, it is determined whether or not this environmental temperature is the normal temperature (step 2). If it is determined that the environmental temperature is 25° C. to 30° C. (inclusive) belonging to the normal temperature range, the fixing control temperature of 170° C. is selected (step 3). At this temperature, the temperature control for the heating roller is executed (step 11).

In step 2, if the environmental temperature is not the normal temperature, it is determined which of a high temperature range, a slightly low temperature range and a low temperature range this temperature belongs to (step 4). In step 4, if the environmental temperature θ1 is higher than 30° C. belonging to the high temperature range, the fixing control temperature of 165° C. is selected (step 5). At this temperature, the temperature control for the heating roller is executed (step 11).

Likewise, in step 4, if it is determined that the environmental temperature θ1 is 15° C. to 25° C. (inclusive) belonging to the slightly low temperature range, the fixing control temperature of 180° C. is selected (step 6). At this temperature, the temperature control for the heating roller is executed (step 11).

Further, in step 4, if it is determined that the environmental temperature θ1 is 0° C. or lower to 15° C. (inclusive), the fixing control temperature of 185° C. is selected (step 7). Further, it is determined whether or not the temperature θ2 is 130° C. or higher (step 8). In step 8, if the temperature θ2 is 130° C. or higher, it is determined whether the accumulated heat total value referred to is not smaller than or smaller than a set value (step 9). If this value is smaller than the set value, the fixing stabilizing time is set (step 10). In step 8, if the temperature θ2 is lower than 130° C., the fixing stabilizing time is set at 20 sec which is a prescribed time (step 10). Thereafter, on the basis of this fixing stabilizing time and fixing control temperature of 185° C., the temperature control for the heating roller is executed (step 11).

In this way, in accordance with the fixing device according to the first embodiment, an image forming apparatus and a facsimile apparatus which are provided with the fixing device, the offset generated at both ends of the heating roller can be reduced to form a preferred image regardless of an open air environmental temperature. In addition, taking the harmony between the fixing strength and the offset, the sheet feeding failure and jam can be prevented.

This invention can be applied to an image forming apparatus which forms an image through electrophotography using toner, in the facsimile, printer or composite machine.

This application is based upon and claims the benefit of priority of Japanese Patent Application No. 2006-072347 filed on Mar. 16, 2006, the contents of which are incorporated herein by reference in its entirety.

What is claimed is:

1. A fixing device comprising:
a heating roller for heating a toner on a recording medium;
a pressurizing roller for being located oppositely to said heating roller and bringing said recording medium into pressure-contact with said heating roller;
an environmental temperature sensor for detecting an environmental temperature around a predetermined device, the fixing device being provided within the predetermined device;
a fixing temperature sensor for detecting the surface temperature of said heating roller; and
a control unit for controlling the heating temperature of said heating roller, wherein
said heating roller has a heater, the heater having a luminous-intensity distribution characteristic generating identical heat at both ends and a center in a longitudinal direction of said heating roller.

2. A fixing device according to claim 1, wherein said control unit determines which level of a plurality of temperatures said environmental temperature belongs to and controls said heating temperature to a prescribed temperature capable of obviating shortage in fixing strength and offset based on the determined temperature level.

3. A fixing device according to claim 1, wherein said heater has a light emitting characteristic with a luminous intensity of 100%.

4. A fixing device according to claim 2, wherein said temperature levels are four levels of a normal temperature range of 25° C. to 30° C. (inclusive), a high temperature range higher than 30° C., a slightly low temperature range of 15° C. to 25° C. (inclusive) and a low temperature range of 15° C. or lower.

5. A fixing device according to claim 4, wherein said prescribed temperature capable of the shortage in fixing strength and offset is 170° C. in said normal temperature range, 165° C. in said high temperature range, 180° C. in said slightly low temperature range and 185° C. in said low temperature range.

6. A fixing device according to claim 5, wherein if the surface temperature of said heating roller is lower than 130° C. in said low temperature range, a fixing stabilizing period is set before fixing is carried out.

7. A fixing device according to claim 6, wherein a plurality of guides are provided on an ejecting side of said heating roller and said pressurizing roller, the plurality of guides guide a fixed recording medium guide, the plurality of guides have notches at both ends in a width direction of a carrying path, so that both ends of the recording medium ejected from said heating roller and said pressurizing roller are fed through the notches without hitting both ends of the plurality of guides.

8. A fixing device according to claim 1, wherein a face layer with coarseness of 0.6 Ra is formed on the surface of said heating roller.

9. An image forming apparatus comprising:
a photosensitive element for forming an electrostatic latent image;
a developer for developing said electrostatic latent image;
a transfer roller for transferring the developed visible image on a carried recording medium; and
a fixing device according to claim 1.

10. A facsimile apparatus comprising:
the image forming device according to claim 9;
a communication controller connected to a communication line for performing a facsimile communication; and
an image reader for reading an image on a document,
wherein during facsimile transmission, said document is read by said image reader, and said image is transmitted through said communication line.

11. A fixing device according to claim 1, wherein the predetermined device comprises a facsimile apparatus.
